(19) United States
(12) Patent Application Publication
(10) Pub. No.: US 2010/0105450 A1
(43) Pub. Date: Apr. 29, 2010

(54) APPARATUS AND METHOD FOR REDUCING POWER CONSUMPTION OF MOBILE STATION IN WIRELESS COMMUNICATION SYSTEM

(75) Inventor: Yi-Ha YOON, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/534,425

(22) Filed: Aug. 3, 2009

(30) Foreign Application Priority Data
Oct. 27, 2008 (KR) 10-2008-0105143

(51) Int. Cl. H04M 1/00

(52) U.S. Cl. 455/574

(57) ABSTRACT

An apparatus and method for reducing the power consumption of a mobile station (MS) supporting at least two communication networks including a Universal Mobile Access (UMA) network are provided. In the method, if a serving network is not a UMA network, whether a UMA network exists in the neighborhood of the serving network is determined. If a UMA network exists in the neighborhood of the serving network, a UMA control unit controlling communication with a UMA network converts to a sleep mode. If at least one UMA network exists in the neighborhood of the serving network, a UMA network scanning operation is performed using the UMA control unit.

### PRIORITY

This application claims the benefit under 35 U.S.C. §119(a) of a Korean patent application filed in the Korean Intellectual Property Office on Oct. 27, 2008 and assigned Serial No. 10-2008-0105143, the entire disclosure of which are hereby incorporated by reference.

### BACKGROUND OF THE INVENTION

1. Field of the Invention

The present invention relates to an apparatus and method for reducing the power consumption of a Mobile Station (MS) in a wireless communication system. More particularly, the present invention relates to an apparatus and method for reducing the power consumption of an MS caused by a continuous Universal Mobile Access (UMA) network scanning operation in a wireless communication system.

2. Description of the Related Art

Due to developments of communication technologies, a wireless communication system may include a mixture of various networks. For example, a wireless communication system may include a mixture of a Global System for Mobile communications (GSM) network, a Universal Mobile Telecommunication System (UMTS) network, and a UMA network.

If a wireless communication system includes a mixture of a GSM network, a UMTS network and a UMA network, a Mobile Station (MS) supporting all of the GSM, UMTS and UMA networks prefers the UMA network because the service fee of the UMA network is lower than the service fees of other networks. Accordingly, the MS may continuously perform a UMA network scanning operation in order to acquire a UMA network.

A UMA network has smaller service coverage area than other networks. Thus, a UMA network may not exist within an active radius of an MS preferring a UMA network. However, the MS preferring a UMA network consumes power unnecessarily because it performs a UMA network scanning operation even when a UMA network does not exist within the active radius of the MS.

### SUMMARY OF THE INVENTION

An aspect of the present invention is to address at least the above-mentioned problems and/or disadvantages and to provide at least the advantages described below. Accordingly, an object of the present invention is to provide an apparatus and method for reducing the power consumption of an MS caused by a UMA network scanning operation in a wireless communication system.

Another object of the present invention is to provide an apparatus and method for controlling an MS not to perform a UMA network scanning operation if a UMA network does not exist within an active radius of the MS in a wireless communication system.

Another object of the present invention is to provide an apparatus and method for transmitting information about the presence of a UMA network from a serving station to an MS in a wireless communication system in order to control a UMA network scanning operation of the MS.

Another object of the present invention is to provide an apparatus and method for converting a UMA control unit to a sleep mode if a UMA network does not exist within an active radius of an MS in a wireless communication system.

According to an aspect of the present invention, a method for reducing power consumption of an MS supporting at least two communication networks including a UMA network is provided. The method includes if a serving network is not a UMA network, determining whether a UMA network exists in the neighborhood of the serving network, if a UMA network exists in the neighborhood of the serving network, converting a UMA control unit controlling communication with a UMA network to a sleep mode, and if at least one UMA network exists in the neighborhood of the serving network, performing a UMA network scanning operation by using the UMA control unit.

According to another aspect of the present invention, an apparatus for reducing the power consumption of an MS supporting at least two communication networks including a UMA network is provided. The apparatus includes a first control unit for controlling, if a serving network is not a UMA network, a UMA control unit according to the information about the presence of a UMA network received from the serving network, a first communication module for communicating signals with the serving network under the control of the first control unit, the UMA control unit for performing a UMA network scanning operation if a UMA network exists in the neighborhood of the serving network and for converting to a sleep mode if a UMA network does not exist in the neighborhood of the serving network under the control of the first control unit, and a second communication module for communicating signals with a UMA network under the control of the UMA control unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating a process for converting an operation mode of a UMA control unit of an MS in a wireless communication system according to an exemplary embodiment of the present invention;

FIG. 2 is a flow diagram illustrating a process for controlling an operation mode of a UMA control unit in a wireless communication system according to an exemplary embodiment of the present invention;

FIG. 3 is a flow diagram illustrating a process for controlling an operation mode of a UMA control unit in a wireless communication system according to an exemplary embodiment of the present invention; and

FIG. 4 is a block diagram illustrating an MS in a wireless communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for reducing the power consumption of a Mobile Station (MS) caused by a continuous UMA network scanning operation in a wireless communication system.

The following description is made on the assumption that a wireless communication system includes a mixture of various networks. For example, the wireless communication system includes a mixture of a GSM network, a UMTS network and a UMA network.

Also, the following description is made assuming that an MS supports GSM and UMA, to which the present invention is not limited. Thus, it should be clearly understood that the present invention is also applicable to an MS supporting UMTS and UMA and an MS supporting GSM, UMTS and UMA. That is, the present invention is also applicable to an MS that prefers a UMA network while supporting various communication schemes including UMA.

If an MS supports GSM and UMA, the MS includes a GSM control unit controlling communication with a GSM network and a UMA control unit controlling communication with a UMA network. Accordingly, if the MS is served by a UMA network, it communicates using the UMA control unit. In this case, the MS controls the GSM control unit to be deactivated. If the MS is served by a GSM network, it communicates using the GSM control unit. In this case, in order to reduce its power consumption, the MS controls the UMA control unit to perform a UMA network scanning operation only when a UMA network exists within the active radius of the MS. Herein, the GSM control unit includes a Radio Resource (RR) that controls communication with a GSM network in the protocol layer of the MS, and the UMA control unit includes a General Access-Radio Resource (GA-RR) that controls communication with a UMA network in the protocol layer of the MS.

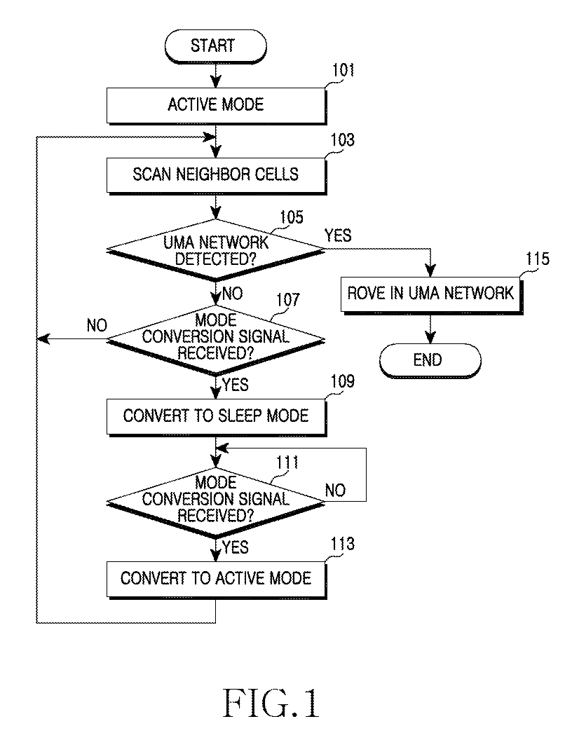

If the MS controls the UMA control unit to perform a UMA network scanning operation only when a UMA network exists within the active radius of the MS, the UMA control unit operates as illustrated in FIG. 1.

FIG. 1 is a flowchart illustrating a process for converting an operation mode of a UMA control unit of an MS in a wireless communication system according to an exemplary embodiment of the present invention.

Referring to FIG. 1, in step 101, a UMA control unit operates in an active mode.

In step 103, the UMA control unit scans neighbor cells in order to acquire a UMA network.

In step 105, the UMA control unit determines whether a UMA network is detected through the above scanning operation.

If a UMA network is not detected in step 105, the UMA control unit proceeds to step 107. In step 107, the UMA control unit determines whether a mode conversion signal is received from a GSM control unit of the MS.

If the mode conversion signal is not received for a preset time in step 107, the UMA control unit returns to step 103 to scan neighbor cells in order to acquire the UMA network.

In contrast, if the mode conversion signal is received in step 107, the UMA control unit proceeds to step 109. In step 109, the UMA control unit converts to a sleep mode.

In step 111, the UMA control unit determines whether the mode conversion signal is received from the GSM control unit.

If the mode conversion signal is not received in step 111, the UMA control unit maintains the sleep mode and determines whether the mode conversion signal is received from the GSM control unit.

If the mode conversion signal is received in step 111, the UMA control unit proceeds to step 113. In step 113, the UMA control unit converts to an active mode.

Thereafter, the UMA control unit returns to step 103 to scan neighbor cells in order to acquire a UMA network.

If a UMA network is detected through the scanning operation in step 105, the UMA control unit proceeds to step 115. In step 115, the UMA control unit roves in the detected UMA network. For example, if the MS is served by a GSM network and operates in a standby mode, the MS releases the connection with the GSM network. Thereafter, the MS attempts to access the UMA network detected using the UMA control unit. As another example, if the MS is served by a GSM network and communicates through the GSM network, the MS hands in the UMA network detected using the UMA control unit.

Thereafter, the UMA control unit ends the process of an exemplary embodiment of the present invention.

In the above exemplary embodiment, it is assumed that the UMA control unit is set to an active mode when the MS turns on.

In another exemplary embodiment, if the UMA control unit is set to a sleep mode when the MS turns on, the UMA control unit performs an operation mode conversion process from step 109 of FIG. 1.

In this case, the operation mode of the UMA control unit, when the MS turns on, depends on the setting of the MS. That is, depending on the setting of the MS, the UMA control unit operates in an active mode or a sleep mode when the MS turns on.

Also, the operation mode of the UMA control unit, when the MS turns on, may depend on the type of a serving network when the MS turns off. That is, if the serving network is the UMA network when the MS turns off, the UMA control unit operates in an active mode when the MS turns on. In contrast, if the serving network is not the UMA network when the MS turns off, the UMA control unit operates in a sleep mode when the MS turns on.

Accordingly, the MS detects and stores the type of a serving network when the MS turns off. For example, if the serving network is the UMA network when the MS turns off, the MS sets LAST_ACTIVE_RAT to TRUE. In this case, the UMA control unit operates in an active mode when the MS turns on. In contrast, if the serving network is not the UMA network when the MS turns off, the MS sets LAST_ACTIVE_RAT to FALSE. In this case, the UMA control unit operates in a sleep mode when the MS turns on.

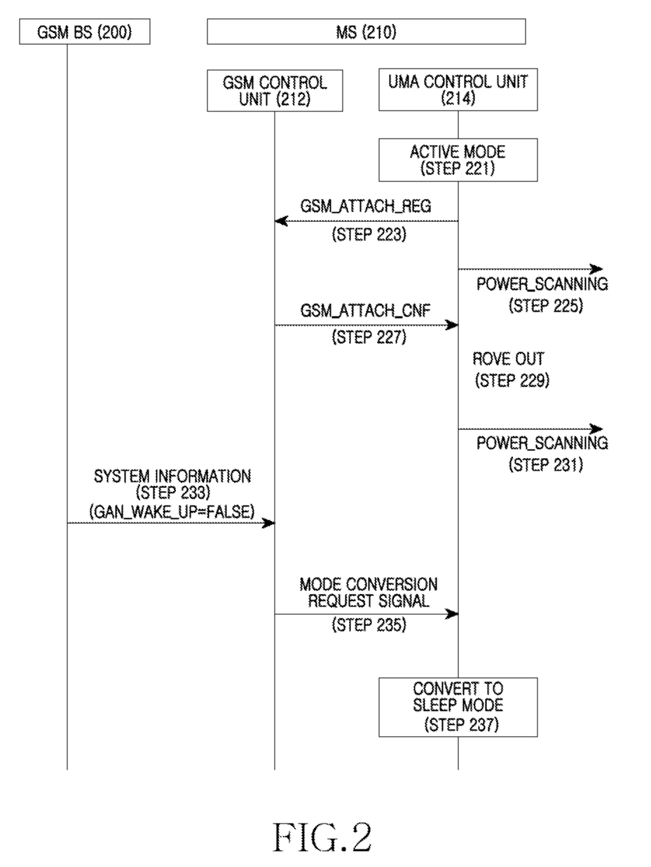

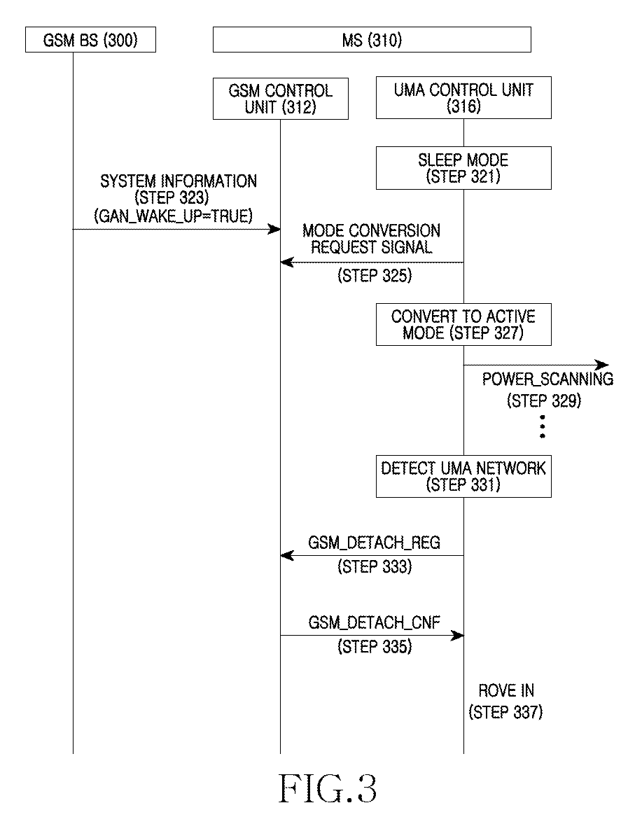

In order to reduce the power consumption caused by a UMA network scanning operation, the MS controls the UMA control unit to perform a UMA network scanning operation only when a UMA network exists in the active radius of the MS. Herein, as illustrated in FIGS. 2 and 3, the MS may determine the presence of a UMA network in the neighborhood on the basis of system information received from the GSM network.

FIG. 2 is a flow diagram illustrating a process for controlling an operation mode of a UMA control unit in a wireless communication system according to an exemplary embodiment of the present invention.

Referring to FIG. 2, if an MS 210 is served by a UMA network, a UMA control unit 214 of the MS 210 operates in an active mode in step 221.

If the quality of communication with the UMA network degrades, the UMA control unit 214 transmits a GSM connection request signal (GSM_ATTACH_REQ) to a GSM control unit 212 in step 223.

According to the GSM connection request signal, the GSM control unit 212 connects to a GSM base station (BS) 200. Thereafter, the GSM control unit 212 transmits a GSM connection response signal (GSM_ATTACH_CNF) to the UMA control unit 214 in step 227.

After transmitting the GSM connection request signal, the UMA control unit 214 performs a UMA network scanning operation in order to determine the presence of another UMA network in step 225. That is, because the MS 210 prefers a UMA network, the UMA control unit 214 performs a UMA network scanning operation in order to determine if another UMA network providing a good communication quality exists.

If a UMA network is not detected through the above scanning operation and the GSM connection response signal is received from the GSM control unit 212, the UMA control unit 214 roves out in step 229. That is, the UMA control unit 214 releases the connection with the UMA network that served the MS 210.

Thereafter, the UMA control unit 214 continues to perform a UMA network scanning operation in step 231. If a UMA network is detected, the UMA control unit 214 roves in the detected UMA network. That is, the UMA control unit 214 connects to the detected UMA network. In contrast, if a UMA network is not detected, the UMA control unit 214 continues to perform a UMA network scanning operation.

The GSM BS 200 determines if a UMA network exists in the neighborhood to notify the presence of a UMA network to the MS 210 in step 233. For example, the GSM BS 200 adds a field, which indicates the presence of a UMA network, in a free space of system information to notify the presence of a UMA network to the MS 210. Herein, the GSM BS 200 adds a field, which indicates the presence of a UMA network, in a free space of system information 3 or system information 6 to notify the presence of a UMA network to the MS 210. Hereinafter, the field indicating the presence of a UMA network will be referred to as a GAN_WAKE_UP field.

The GSM control unit 212 determines if a UMA network in the neighborhood on the basis of the system information received from the GSM BS 200 exists. Herein, if the GAN_WAKE_UP field is FALSE, the GSM control unit 212 determines that a UMA network does not exist in the neighborhood, and if the GAN_WAKE_UP field is TRUE, the GSM control unit 212 determines that a UMA network exists in the neighborhood.

If a UMA network does not exist in the neighborhood, the GSM control unit 212 transmits a mode conversion request signal to the UMA control unit 214 in step 235.

Upon receiving the mode conversion request signal from the GSM control unit 212, the UMA control unit 214 stops a UMA network scanning operation and converts to a sleep mode in step 237.

As described above, if a UMA network does not exist within the active radius of the MS, the MS controls the UMA control unit to operate in a sleep mode. In contrast, if a UMA network exists within the active radius of the MS, the MS controls the UMA control unit to convert to an active mode, as illustrated in FIG. 3.

FIG. 3 is a flow diagram illustrating a process for controlling an operation mode of a UMA control unit in a wireless communication system according to an exemplary embodiment of the present invention.

Referring to FIG. 3, if an MS 310 is served by a GSM network and a UMA network does not exist in the neighborhood, a UMA control unit 314 of the MS 310 operates in a sleep mode in step 321. Herein, the MS 310 uses a GSM control unit 312 to connect to a GSM BS 300 to receive a communication service.

The GSM BS 300 determines if a UMA network exists in the neighborhood to notify the presence of a UMA network to the MS 310 in step 323. For example, the GSM BS 300 adds a field, which indicates the presence of a UMA network, in a free space of system information to notify the presence of a UMA network to the MS 310.

The GSM control unit 312 determines if a UMA network exists in the neighborhood on the basis of the system information received from the GSM BS 300. Herein, if the GAN_WAKE_UP field is FALSE, the GSM control unit 312 determines that a UMA network does not exist in the neighborhood, and if the GAN_WAKE_UP field is TRUE, the GSM control unit 312 determines that a UMA network exists in the neighborhood.

If a UMA network exists in the neighborhood, the GSM control unit 312 transmits a mode conversion request signal to the UMA control unit 314 operating in a sleep mode in step 325.

Upon receiving the mode conversion request signal, the UMA control unit 314 converts to an active mode in step 327.

Thereafter, the UMA control unit 314 performs a UMA network scanning operation in step 329. If a UMA network is not detected, the UMA control unit 314 continues to perform a UMA network scanning operation.

In contrast, if a UMA network is detected in step 331, the UMA control unit 314 transmits a GSM connection release request signal (GSM_DETACH_REQ) to the GSM control unit 312 in step 333.

According to the GSM connection release request signal, the GSM control unit 312 releases the connection with the GSM BS 300. Thereafter, the GSM control unit 312 transmits a GSM connection release response signal (GSM_DETACH_CNF) to the UMA control unit 314 in step 335.

Upon receiving the GSM connection release response signal, the UMA control unit 314 roves in the detected UMA network in step 337. That is, the UMA control unit 314 connects to the detected UMA network.

Hereinafter, a description will be given of the configuration of an MS that supports GSM and UMA.

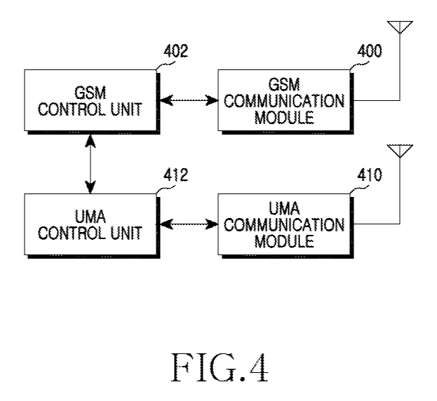

FIG. 4 is a block diagram of an MS in a wireless communication system according to an exemplary embodiment of the present invention.

Referring to FIG. 4, an MS includes a GSM communication module 400, a GSM control unit 402, a UMA communication module 410, and a UMA control unit 412.

The GSM communication module 400 communicates with a GSM network under the control of the GSM control unit 402.

The GSM control unit 402 controls the MS to connect to the GSM network to perform communication. If the MS connects to a UMA network to receive a communication service, the GSM control unit 402 may operate in a sleep mode.

Also, the GSM control unit 402 determines if a UMA network exists in the neighborhood on the basis of system information received from a GSM BS. If it is determined that a UMA network exists in the neighborhood, the GSM control unit 402 transmits a mode conversion request signal so that the UMA control unit 412 operating in a sleep mode converts to an active mode. In contrast, if it is determined that a UMA network does not exist in the neighborhood, the GSM control unit 402 transmits a mode conversion request signal so that the UMA control unit 412 operating in an active mode converts to a sleep mode.

The UMA communication module 410 communicates with a UMA network under the control of the UMA control unit 412.

The UMA control unit 412 controls the MS to connect to the UMA network to perform communication. If the MS connects to a UMA network to receive a communication service, the UMA control unit 412 performs a UMA network scanning operation according to whether a UMA network exists within the active range of the MS. For example, if the MS is served by a GSM network, the UMA control unit 412 operating in an active mode performs a UMA network scanning operation. Herein, if a mode conversion request signal is received from the GSM control unit 402, the UMA control unit 412 determines that a UMA network does not exist in the neighborhood. Accordingly, the UMA control unit 412 converts to a sleep mode. In contrast, if a mode conversion request signal is received from the GSM control unit 402, the UMA control unit 412 operating in a sleep mode determines that a UMA network exists in the neighborhood. Accordingly, the UMA control unit 412 converts to an active mode to perform a UMA network scanning operation.

In the above exemplary embodiment, the MS determines the operation mode of the UMA control unit on the basis of the information about the presence of a UMA network received from the GSM network. If different network providers operate the GSM network and the UMA network, the MS cannot connect to the UMA network. Thus, the GSM network provides the MS with only information about the presence of the UMA operated by the same network provider.

If the MS can connect the UMA network even when different network providers operate the GSM network and the UMA network, the GSM network may provide the MS with information about the presence of the UMA network located in the neighborhood, regardless of the type of the network provider.

As described above, the present invention controls the UMA network scanning operation of the MS according to whether the UMA network exists in the active radius of the MS preferring the UMA network. Accordingly, the present invention can prevent the MS from performing an unnecessary UMA network scanning operation, thus making it possible to reduce the unnecessary power consumption.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for reducing power consumption of a Mobile Station (MS) supporting at least two communication networks including a Universal Mobile Access (UMA) network, the method comprising:
if a serving network is not a UMA network, determining whether a UMA network exists in the neighborhood of the serving network;
if a UMA network does not exist in the neighborhood of the serving network, converting a UMA control unit controlling communication with a UMA network to a sleep mode; and
if at least one UMA network exists in the neighborhood of the serving network, performing a UMA network scanning operation by using the UMA control unit.

2. The method of claim 1, wherein the determining of whether the UMA network exists comprises determining whether a UMA network exists in the neighborhood of the serving network on the basis of system information received from the serving network.

3. The method of claim 1, wherein the determining of whether the UMA network exists comprises determining whether a UMA network operated by the same network provider as the serving network exists in the neighborhood of the serving network on the basis of system information received from the serving network.

4. The method of claim 1, wherein the performing of the UMA network scanning operation comprises:
if the UMA control unit is in a sleep mode, converting the UMA control unit to an active mode; and
performing the UMA network scanning operation by using the UMA control unit.

5. The method of claim 1, further comprising:
if the MS turns off, storing the type of the serving network; and
if the MS turns on, determining the operation mode of the UMA control unit according to the stored type of the serving network.

6. The method of claim 5, wherein the determining of the operation mode of the UMA control unit comprises:
if the serving network is a UMA network, operating the UMA control unit in an active mode when the MS turns on; and
if the serving network is not a UMA network, operating the UMA control unit in a sleep mode when the MS turns on.

7. The method of claim 1, further comprising determining the operation mode of the UMA control unit according to a preset operation mode of the UMA control unit if the MS turns on.

8. An apparatus for reducing the power consumption of a mobile station (MS) supporting at least two communication networks including a Universal Mobile Access (UMA) network, the apparatus comprising:
a control unit for controlling, if a serving network is not a UMA network, a UMA control unit according to the information about the presence of a UMA network received from the serving network;
a first communication module for communicating signals with the serving network under the control of the control unit;
the UMA control unit for performing a UMA network scanning operation if a UMA network exists in the neighborhood of the serving network and for converting to a sleep mode if a UMA network does not exist in the neighborhood of the serving network, under the control of the control unit; and
a second communication module for communicating signals with a UMA network under the control of the UMA control unit.

9. The apparatus of claim 8, wherein the control unit determines whether a UMA network exists in the neighborhood of the serving network on the basis of system information received from the serving network.

10. The apparatus of claim 8, wherein the control unit determines whether a UMA network operated by the same network provider as the serving network exists in the neighborhood of the serving network on the basis of system information received from the serving network.

11. The apparatus of claim 8, wherein the control unit controls the UMA control unit to perform a UMA network scanning operation if at least one UMA network exists in the neighborhood of the serving network, and controls the UMA control unit to operate in a sleep mode if a UMA network does not exist in the neighborhood of the serving network.

12. The apparatus of claim 8, wherein the control unit includes a Radio Resource (RR) if the serving network is a Global System for Mobile communications (GSM) network, and includes a Radio Resource Control (RRC) if the serving network is a Universal Mobile Telecommunication System (UMTS) network.

13. The apparatus of claim 8, wherein if the control unit controls the UMA control unit to perform a UMA network scanning operation in a sleep mode, the UMA control unit converts to an active mode to perform a UMA network scanning operation.

14. The apparatus of claim 8, wherein the UMA control unit includes a General Access-Radio Resource (GA-RR).

15. The apparatus of claim 8, wherein the UMA control unit determines the operation mode of the MS when the MS turns on according to the type of the serving network when the MS turns off.

16. The apparatus of claim 15, wherein the UMA control unit operates in an active mode when the MS turns on if a UMA network is the serving network when the MS turns off, and operates in a sleep mode when the MS turns on if a UMA network is not the serving network when the MS turns off.

17. The apparatus of claim 8, wherein the UMA control unit determines the operation mode of the UMA control unit according to a preset operation mode of the UMA control unit when the MS turns on.

18. A method for reducing power consumption of a Mobile Station (MS) supporting at least two communication networks including a Universal Mobile Access (UMA) network, the method comprising:
if a serving network is not a UMA network, scanning neighbor cells to acquire a UMA network;
determining whether a UMA network exists in the neighborhood of the serving network;
if a UMA network does not exist in the neighborhood of the serving network, converting a UMA control unit controlling communication with a UMA network to a sleep mode;
determining periodically whether a mode conversion signal is received from the serving network;
if a mode conversion signal is not received, maintaining the UMA control unit in the sleep mode; and
if a mode conversion signal is received, converting the UMA control unit to an active mode in order to scan neighbor cells.

19. The method of claim 18, wherein the determining of whether the UMA network exists comprises determining whether a UMA network exists in the neighborhood of the serving network on the basis of system information received from the serving network.

20. The method of claim 18, wherein the determining of whether the UMA network exists comprises determining whether a UMA network operated by the same network provider as the serving network exists in the neighborhood of the serving network on the basis of system information received from the serving network.
